(19) United States
(12) Patent Application Publication
(10) Pub. No.: US 2013/0192968 A1
(43) Pub. Date: Aug. 1, 2013

(54) SINGLE-ROW EMERGENCY-STOP SWITCH-CONTACT DEVICE

(71) Applicant: GEORG SCHLEGEL GMBH & CO. KG, Durmentingen (DE)

(72) Inventors: Eberhard SCHLEGEL, Durmentingen (DE); Kurt BLANK, Bad Buchau (DE); Rudolf DOLPP, Obermarchtal-Reutlingendorf (DE)

(73) Assignee: GEORG SCHLEGEL GMBH & CO. KG, Durmentingen (DE)

(21) Appl. No.: 13/803,593

(22) Filed: Mar. 14, 2013

Related U.S. Application Data
(63) Continuation of application No. PCT/EP2011/004624, filed on Sep. 15, 2011.

(30) Foreign Application Priority Data
Sep. 17, 2010 (DE) 10 2010 045 629.2

(51) Int. Cl. H01H 3/02

(52) U.S. Cl. CPC H01H 3/022
USPC 200/502

(57) ABSTRACT

An electrical contact device including first and second switching contact units for producing or isolating electrically conductive connections, wherein a first contact side of the first switching contact unit is connected to a first contact side of the second switching contact unit, and a second contact side of the first switching contact unit is connected to a first connection contact of the contact device, and a second contact side of the second switching contact unit is connected to a second connection contact of the contact device, and wherein two switching contact units are designed to be actuable by a movable plunger acting on said switching contact units. The two connection contacts, in relation to the plunger, are arranged opposite one another on the contact device, and the first and second switching contact units are arranged within a mounting unit.

### CROSS REFERENCE TO RELATED APPLICATIONS

This application is a continuation of International Application No. PCT/EP2011/004624 filed Sep. 15, 2011, which designated the United States, and claims the benefit under 35 USC §119(a)-(d) of German Application No. 10 2010 045 629.2 filed Sep. 17, 2010, the entireties of which are incorporated herein by reference.

### FIELD OF THE INVENTION

The present invention relates to an electrical contact device and to a command device.

### BACKGROUND OF THE INVENTION

For safety reasons, the provision of emergency-stop switches is prescribed for machines and electrical installations. Such emergency-stop switches, as are known, for example, from DE 4 101 493 C2, firstly comprise an electrical contact device and secondly comprise an actuation device provided for the actuation thereof. This two-part design is provided because the actuation device, which is often also referred to as an actuator, needs to be visible and accessible for reliable operation thereof at any time. Only in this way is it possible to ensure that, in the event of a hazard posed by the machines or installations, it is possible for mechanical triggering to take place in accordance with a disconnection switching command provided for this purpose. When such an emergency-stop switch is intended to be arranged on a switchgear cabinet, one option is for the actuation device to be mounted externally on the front-panel side of said switchgear cabinet for reasons of safety and visibility.

In order to be able to correspondingly wire, i.e. make contact with, the electrical contact device, said contact device is preferably arranged within the switchgear cabinet. In order to ensure that the actuation device and the electrical contact device are connected to one another operationally correctly, a switching contact unit is provided for the latter, which switching contact unit produces an electrically conductive connection between its two contact points only when this mechanical connection is actually correct. This changes without delay by virtue of isolation of this electrically conductive connection as soon as the operationally correct connection between the actuation device and the electrical contact device is no longer provided, for example owing to intentional or even unintentional isolation of these two components. This may be the case, for example, during maintenance and/or test work, but isolation can also take place as a result of a mishap or an accident owing to an external action on the actuation device, such as it being knocked or sheared off, for example. In all of these cases, the production of the envisaged safety state for the relevant installation and/or machine necessarily needs to be ensured, which is achieved by the described isolation of the electrically conductive connection.

In order to be able to ensure the operationally envisaged safety measure, such as shutdown or ramping-down of the installation and/or the machine, depending on the safety concept, in the event of a hazard occurring even when this is intended to be signaled, for example, owing to a corresponding event, by actuation of the actuating device, the electrical contact device comprises a second switching contact unit. This is connected in series with the first switching contact unit and isolates an electrically conductive connection between its two contact points, which electrically conductive connection is produced between these two contact points by this switching contact unit during normal operation in the event of operationally correct connection between the actuation device and the electrical contact device.

Such an electrical contact device of an emergency-stop switch thus has three associated switching states, as follows:

1. Both switching contact units produce the electrically conductive connection between their two electrical contact points which is intended to be realized by said switching contact units. This is the case when an operationally correct connection is present between the actuation device and the electrical contact device.

2. The first of the two switching contact units isolates the electrically conductive connection between its two electrical contact points which is to be produced by said first switching contact unit during correct operation. This is the case, for example, whenever there is no operationally correct connection between the actuation device and the electrical contact device.

3. The second switching contact unit isolates the electrically conductive connection between its two electrical contact points which is to be produced by said second switching contact unit in the operationally correct state. This is the case when an emergency-stop demand is made by actuation of the actuation device.

### SUMMARY OF THE INVENTION

The present invention is based on the object of improving an electrical contact device in accordance with the prior art described at the outset.

Accordingly, the present invention relates to an electrical contact device, in particular an emergency-stop switch contact device, comprising:

a first switching contact unit for producing or isolating an electrically conductive connection, and

a second switching contact unit for producing or isolating an electrically conductive connection,

wherein a first contact side of the first switching contact unit is connected to a first contact side of the second switching contact unit, and a second contact side of the first switching contact unit is connected to a first connection contact of the contact device, and a second contact side of the second switching contact unit is connected to a second connection contact of the contact device, and wherein two switching contact units are designed to be actuable by a movable plunger acting on said switching contact units. It is characterized by the fact that the two connection contacts, in relation to the plunger, are arranged opposite one another on the contact device, and wherein the first and second switching contact units are arranged within a mounting unit, which is provided for connection to an actuation device.

In this context, a connection contact is understood to mean a contact which is provided for the connection of the electrical contact device to an external line. Such a contact can be in the form of a screw contact, a plug-type contact, a clamping contact or the like, for example. Internally, an electrically conductive contact connecting element leads from the connection contact to the switching contact unit associated with it. This switching contact unit can comprise, for example, a switching bridge, which has two contact points consisting of a corresponding contact material, which contact points for their part each have an associated complementary contact point of a contact connecting element with which contact is to be made, said complementary contact point preferably likewise consisting of a corresponding contact material.

Such electrical contact devices are generally produced in block form, for example in the form of terminal blocks. By virtue of the provision of corresponding latching elements, a simple and reliable connection between the electrical contact device and the actuation device is possible. The design of an electrical contact device as proposed in accordance with the invention is based on the knowledge that the two connection contacts of two series-connected switching contact units, despite maintaining a predetermined physical housing width per switching element, even in the case of a single-row design, do not necessarily need to be passed out on the same housing side, but it is also possible for an opposite connection contact arrangement to be realized, when viewed in the longitudinal direction of the housing, for example, by virtue of a corresponding design and guidance of a contact connecting element, in particular whilst maintaining the correspondingly required line cross section. This has the advantage that an electrical contact device designed in this way saves on half of the space requirement necessary to date in terms of width which was necessary in order to guide one of the two connection contacts, which are guided out on the same side, onto the opposite side by means of a second contact element arranged next to the electrical contact device.

A particularly problematic factor for such a solution approach has been the necessary freedom of movement for the arranged plunger movably in the longitudinal direction in the center through the housing of the electrical contact device and for an actuation of the one respective switching contact unit in accordance with the switching states required for emergency-stop switches, which actuation is independent of the respective other switching contact unit. Firstly, in this case large spatial regions are occupied by elements of a spring system provided for contact control, and secondly, overlaps in these spatial regions also need to be kept free, in particular in the axial direction, in order to be able to enable the required movability of the plunger, the spring elements and the contact elements. A further problem consists in the required distance between the two series-connected switching elements in order to be able to ensure reliable isolation of the electrically conductive connection in question.

In order to realize a single-row electrical contact device comprising two connection contacts which are arranged on two opposite housing sides, various solution approaches could be found. In a first approach, a contact connecting element can be designed and arranged in the interior of the housing in such a way that it runs transversely through the housing from one side to the other in order to produce an electrically conductive connection between a contact point of a switching contact unit and a connection contact, with it being guided laterally past the plunger.

Preferably, this contact connecting element can have a flat, rail-like shape. Thus, a corresponding line cross section can be realized. In order to be able to provide this sufficiently over the entire connecting extent, a connecting section can run “on edge”, i.e. substantially parallel to the plunger movement, between the contact of the switching contact unit and the connection contact. As a result, the remaining space in this connecting region remains freely available for elements of the plunger, the filter system and further contact elements and possibly contact connecting elements. In order to be able to provide the two contact regions of the contact connecting element in an alignment which is conventionally rotated through approximately 90° with respect thereto, i.e. a “flat” alignment, the transition points between the individual connecting sections of the contact connecting element can preferably be bent back, preferably bent back more than once, in order to achieve the described structure profile by virtue of two respectively successive angles.

In an embodiment which is modified in comparison with this, the contact connecting element can, for example, likewise be realized so as to be flat and in the form of a rail, but without the “setting on edge” described in the first embodiment in the intermediate region. Owing to the height of the flat material plus certain tolerances, this results in the required spatial region for the connection of the two contact regions formed on opposite sides of the housing. Owing to this comparatively low spatial height of the contact connecting element, a section in the plunger could be configured such that the contact connecting element can pass through said plunger despite the excursion that is required for the operational actuation of the two switching contact units. In this embodiment, therefore, the contact connecting element can be guided through the plunger.

In both of these embodiments, in each case one connection contact can be arranged at the bottom left and right on an open housing of an electrical contact device, in plan view, for example, via which connection contacts the two switching contact units are arranged spaced apart from one another and such that they can be actuated by the movable plunger. The two switching contact units each have a bridge element, which, in the corresponding switch position, are connected in series with a further contact connecting element in the right-hand upper housing region.

The previously described contact connecting element in this embodiment described by way of example runs from the left contact region of the lower bridge element transversely through the housing to the right connection contact. The contact connecting element which connects the two switching contact units in series in the right upper housing region is therefore only located on one side of the plunger.

In an embodiment which has been modified in comparison with this, the contact connecting element could be arranged so as to run transversely from one side of the housing to the other side of the housing, which contact connecting element connects the two switching contact units in series, for example also instead of the contact connecting element which connects a contact of a switching contact unit to a connection contact. In this embodiment, both contact connecting elements which connect a switching contact unit to a connection contact could then only be formed on the respective housing side, on the left or on the right, on which these two contacts are located. The guidance of the line transversely through the housing, laterally past the plunger and/or through said plunger would then take place as a result of the contact connecting element connecting the two switching contact units in series. The formation and the line guidance could accordingly be realized in a corresponding manner, as described above in relation to the contact connecting element which connects a switching contact unit to a connection contact.

In order to be able to position the two switching contact units in the case of an operationally correct connection between the electrical contact device and the actuation device in such a way that said switching contact units can produce respectively the electrically conductive connection associated with them by closing the contact points in question, the plunger comprises a plunger head. This plunger head interacts with a complementary mechanism, which effects those three switching states for the electrical contact device as are described with reference to the respective actuation case of the actuation device in the prior art set out at the outset, namely produces both electrically conductive connections during conventional operation, isolates a first of the two electrically conductive connections in the event of a fault and isolates the second of the two electrically conductive connections in the emergency-stop demand switching state.

The spring system provided for positioning the plunger and/or a switching contact unit can comprise two separate spring elements, for example in the form of helical springs. A first spring element can in this case prestress the movable plunger in the axial direction, for example, by applying a spring force to the end side, with the result that, given a corresponding freedom of movement of the plunger (incorrect connection between electrical contact connecting element and actuation device), the electrically conductive connection in question is isolated by repositioning of the bridge element in question.

A second spring element can act on the other bridge element, for example, in such a way that said other bridge element produces the electrically conductive connection associated therewith for the relevant switching contact unit in the case of a correct connection between the electrical contact device and the actuation device, but isolates the electrically conductive connection, by actuation of the actuation device, in the event of an emergency-stop demand case.

Therefore, both switching contact units can be activated by such a spring system.

The present invention further relates to a command device, in particular an emergency-stop switch with an electrical contact device in accordance with one of the above-described embodiments and an actuation device provided for the actuation thereof.

### BRIEF DESCRIPTION OF THE DRAWINGS

Various embodiments will be described in more detail below with reference to the attached figures, in which:

FIGS. 1 and 2 show two different embodiments of an electrical contact device, in particular an emergency-stop switch contact device;

FIG. 3 shows an alternative circuit arrangement to the embodiments shown in FIGS. 1 and 2; and

FIG. 4 shows a command device, in particular an emergency-stop switch.

### DETAILED DESCRIPTION OF THE INVENTION

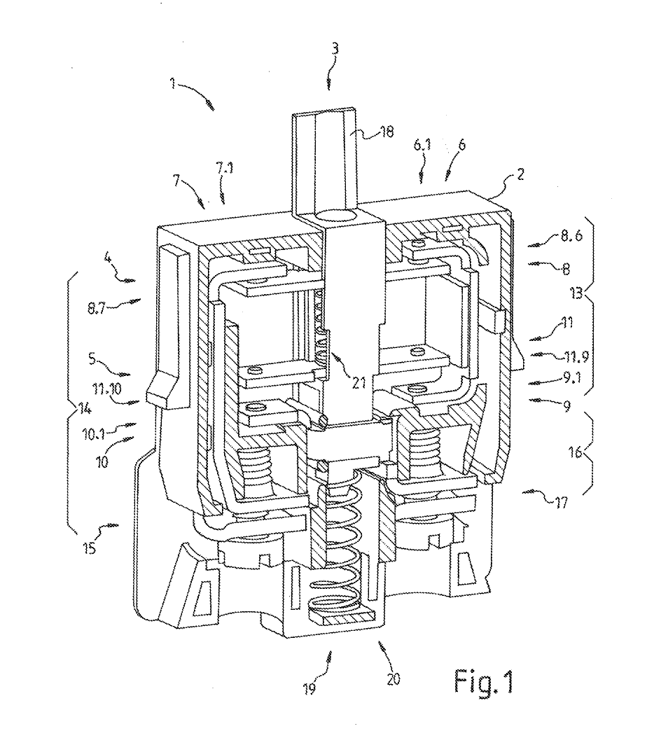

Accordingly, FIG. 1 shows an electrical contact device 1 with a housing 2 and a plunger 3 guided movably therein. The contact device 1 comprises a first and a second switching contact unit 4, 5, in each case for producing or isolating an electrically conductive connection depending on the plunger position along the axially provided positioning thereof corresponding to the switching positions prescribed for emergency-stop switches and illustrated in detail above. The first switching contact unit 4 comprises a first contact side 6, a second contact side 7 and a bridge element 8 connecting the respective contact points 6.1 and 7.1 of said contact sides. The bridge element can preferably also have contact points 8.6 and 8.7 consisting of a corresponding contact material. In the state illustrated, the closed switching contact unit 8 produces an electrically conductive connection.

Correspondingly, the second switching contact unit 5 comprises a first contact side 9 and a second contact side 10 with corresponding contact points 9.1 and 10.1 and a bridge element 11 and preferably contact points 11.9 and 11.10 formed thereon. Given a corresponding switching position of the plunger 3 for producing an electrically conductive connection, the relevant contacts are connected by being closed. In the state illustrated, this second electrically conductive connection is isolated owing to the switching position of the plunger 3, however.

A first contact connecting element 13 connects the first contact side 6 of the first switching contact unit to a first contact side 9 of the second switching contact unit in order to connect the two units in series.

A second contact connecting element 14 connects the second contact side 7 of the first switching contact unit to a first connection contact 15, by means of which contact can be made between the electrical contact device and an external conductor via the screw connection illustrated by way of example here.

A third contact connecting unit 16 connects the second end of this series circuit comprising the first and second switching contact units on the second contact side 10 of the second contact unit to a second connection contact 17. As a result, the second external connection to the electrical contact device can be realized via the screw connection, again illustrated by way of example.

In this way, the two electrical switching contact units are arranged within the housing 2, which represents a single-row mounting unit, and are positioned by the plunger corresponding to the respective switching position thereof. In a particularly advantageous manner, a single-row circuit design can be realized despite these two connection contacts which are arranged on opposite sides of the housing 2 in relation to the plunger.

In order to actuate the plunger 3 by means of an actuating device (not illustrated here), this plunger has a plunger head 18. In the embodiment illustrated, this plunger head is arranged on the plunger at one end and protrudes beyond the housing 2. In order to position the plunger and/or a switching contact unit or else both switching contact units, a spring system 19 is furthermore provided. This comprises a first spring 20, which acts on the plunger at one end, and a second spring 21, which acts on the first bridge element by way of example here.

In this embodiment, the contact connecting element 16 has a flat, rail-like form, which is arranged in the central connecting region between the two contacts 10 and 17 so as to be “set on edge” by virtue of being bent back a plurality of times. That is to say that, in comparison with the other alignments that can be referred to as being arranged flat, for example, in the illustration in the figure, this section of the contact connecting element 16 is arranged or formed vertically. This advantageously enables lateral guidance past the plunger 3. As a result, a comparatively large line cross section can also be realized without the cross-sectional region which needs to be made available for the plunger movement needing to be reduced in the same wav.

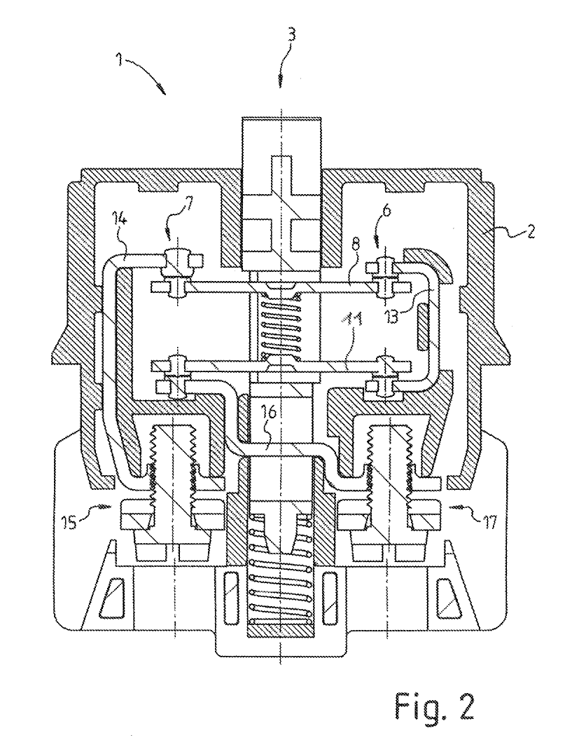

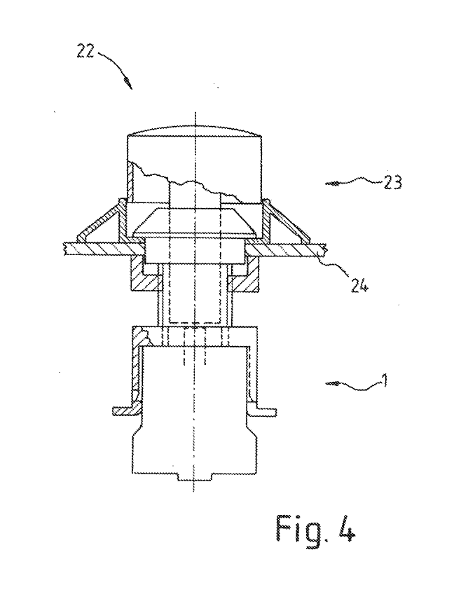

The embodiment of an electrical contact device illustrated in FIG. 2 in principle shows a similar design to the embodiment shown in FIG. 1. In contrast to this embodiment, in FIG. 4 the contact connecting element 16 is not bent back in such a way that it is guided laterally past the plunger, however, but remains in its form which is in principle flat in a plane and is passed through a cutout in the plunger.

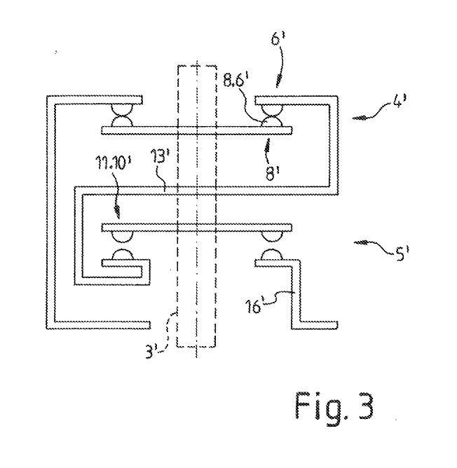

FIG. 3 shows an embodiment which has been modified in comparison with the two first circuit arrangements to the extent that the first contact connecting element 131 connects the contact 8.6′ of the first bridge element 8′ to that contact 11.10 of the second bridge element 11′ which is opposite the plunger 3′ in the position in which it is arranged in the housing. For this purpose, the contact connecting element 13′ runs in a corresponding manner to the third contact connecting element 16 in the embodiments in FIGS. 1 and 2. Both an arrangement which is guided laterally past the plunger and an arrangement guided through the plunger can also be provided here for this circuit arrangement, which is merely illustrated schematically by way of example here.

The third contact connecting element 16′ accordingly only runs on the right-hand side, in relation to the illustration, in the housing, i.e. on the right and only on one side of the plunger 3′.

FIG. 4 illustrates a command device 22 comprising an electrical contact device 1 and an actuator 23, to be precise in a state in which the command device is installed in a wall 24.

### LIST OF REFERENCE SYMBOLS

1 Electrical contact device
2 Housing/mounting unit
3 Plunger
4 First switching contact unit
5 Second switching contact unit
6 First contact side
7 Second contact side
8 First bridge element
9 First contact side
10 Second contact side
11 Second bridge element
13 First contact connecting element
14 Second contact connecting element
15 First connection contact
16 Third contact connecting element
17 Second connection contact
18 Plunger head
19 Spring system
20 First spring
21 Second spring
22 Command device
23 Actuator
24 Wall

We claim:

1. An electrical contact device, in particular an emergency-stop switch contact device, comprising:
a first switching contact unit for producing or isolating an electrically conductive connection, and
a second switching contact unit for producing or isolating an electrically conductive connection,
wherein a first contact side of the first switching contact unit is connected to a first contact side of the second switching contact unit, and a second contact side of the first switching contact unit is connected to a first connection contact of the contact device, and a second contact side of the second switching contact unit is connected to a second connection contact of the contact device, and wherein two switching contact units are designed to be actuable by a movable plunger acting on said switching contact units, wherein the two connection contacts, in relation to the plunger, are arranged opposite one another on the contact device, and wherein the first and second switching contact units are arranged within a mounting unit, which is provided for connection to an actuation device.

2. The electrical contact device as claimed in claim 1, wherein the electrical contact device has a single-row design.

3. The electrical contact device as claimed in claim 1, wherein a contact connecting element is provided which forms an electrical connection between a contact point on a first side of the plunger and a contact point on that side of the plunger which is opposite the first side.

4. The electrical contact device as claimed in claim 1, wherein a contact connecting element connects a contact side of a switching contact unit to a connection contact.

5. The electrical contact device as claimed in claim 1, wherein a contact side connecting element connects a contact of the first switching contact unit to a contact side of the second switching contact unit.

6. The electrical contact device as claimed in claim 1, wherein the contact connecting element is guided laterally past the plunger.

7. The electrical contact device as claimed in claim 1, wherein the contact connecting element is guided through the plunger.

8. The electrical contact device as claimed in claim 1, wherein a bridge element of a switching contact unit is guided through the plunger.

9. The electrical contact device as claimed in claim 1, wherein a bridge element of a switching contact unit is guided past the plunger.

10. The electrical contact device as claimed in claim 1, wherein the plunger has a plunger head.

11. The electrical contact device as claimed in claim 1, wherein a spring system for positioning the plunger and/or a switching contact unit is provided.

12. The electrical contact device as claimed in claim 1, wherein a spring system for positioning both switching contact units is provided.

13. The electrical contact device as claimed in claim 1, wherein the first and second switching contact units, in the event of an operationally correct connection between the contact device and an actuating element provided for actuating said contact device, produce the respectively associated electrically conductive connection.

14. The electrical contact device as claimed in claim 1, wherein the first switching contact unit, in the event of an operationally incorrect connection between the contact device and the actuating element provided for the actuation thereof, isolates the electrically conductive connection associated with said first switching contact unit.

15. The electrical contact device as claimed in claim 1, wherein the second switching contact unit, on activation of the actuating element, isolates the electrically conductive connection associated with said second switching contact unit.

16. A command device, in particular an emergency-stop switch, comprising an electrical contact device as claimed in claim 1 and an actuation device.
